(19) United States
(12) Patent Application Publication
(10) Pub. No.: US 2026/0257442 A1
(43) Pub. Date: Sep. 3, 2026

(54) RADIAL EXPANDING TIRE BEAD SEALING RING ASSEMBLY

(71) Applicant: Tripoint LLC (dba Presti Industries), Warminster, PA (US)

(72) Inventor: Barry Presti, Doylestown, PA (US)

(21) Appl. No.: 19/555,216

(22) Filed: Mar. 3, 2026

Related U.S. Application Data
(60) Provisional application No. 63/766,241, filed on Mar. 3, 2025.

(51) Int. Cl. B29D 30/54

(52) U.S. Cl. CPC B29D 30/542

(57) ABSTRACT

A radial expanding tire bead sealing ring assembly to create a hermetic seal during the retreading curing process for radial tires. The assembly includes a radially expanding metal ring with a spring-loaded locking mechanism and an annular resilient elastomeric radial sealing ring. The spring-loaded locking mechanism includes at least some subset of (a) multiple pivot points to provide a wider working range of circumference to accommodate variations in tire brands, manufacturing and wear, (b) an indexing mechanical stop to control the working range, (c) a specific pivot point which bypasses the mechanical stop, (d) an integrated site gauge, (e) a J-hook saddle, (f) an integrated sled bearing, (g) a housing rail standoff, and (h) an integrated ergonomical hollow handle. The metal ring may include a J-hook saddle on an opposite side from the locking mechanism.

### BACKGROUND

Retreading tires is a sustainable, cost-effective manufacturing process that replaces the worn tread on a used tire casing with new rubber, extending its life and reducing waste. Retreading is commonly used for commercial trucks, aircraft, and heavy-duty vehicles. Retreaded tires offer similar durability and safety to new tires while using significantly less energy to produce. The process of retreading tires includes inspecting the worn tires, buffing the worn tire to remove old tread, repairing any damage to the tire casing, preparing a new rubber tread, and securing the tread to the tire casing. The securing of the new tread to the tire casing includes applying a bonding agent such as uncured rubber (commonly known as cushion gum) to the tire casing and wrapping the tire tread to the casing. The assembly is then enclosed in an annular elastomeric curing envelope (membrane), typically of thin synthetic rubber, or the like.

The annular elastomeric curing envelope is then secured to the tire using a radial expanding tire bead sealing ring assembly such as that disclosed in U.S. Pat. No. 4,634,357. The radial expanding tire bead sealing ring assembly includes a radially expanding metal ring, an annular resilient elastomeric radial sealing ring and an actuating mechanism subassembly with a spring-loaded locking mechanism nested in it. The actuating mechanism subassembly may be utilized as a saddle for receiving a J-hook that is used to hold the tire and curing envelope. The radial expanding tire bead seal ring assembly is inserted into an interior of the tire so that the sealing ring contacts the axial bead of the tire and conforms the curing envelope to the axial bead. By actuating the spring-loaded locking mechanism to a locked position, an outer circumference of the assembly is expanded so as to apply a uniform constant pressure to the rubber seal compressing the curing envelope against the rim area of the tire and forming a hermetic seal.

The curing envelope includes a valve that enables a hose to be connected thereto in order to extract the air (create a vacuum) and evacuate any annular space between the tread and the envelope. This stretches the outer envelope into direct contact with outer sidewalls of the casing and all surfaces of the new tread. This ensures that uniform pressure is applied over the entire bonding area without tread distortion during the curing process. The curing envelope also prevents either air or steam from being entrapped between the tread strip and the casing and migrating into the bonding agent. The entire assembly is then mounted on a J-hook and placed in a curing chamber (autoclave) at elevated temperatures and pressures to vulcanize the uncured components and to positively bond the casing and tread strip together.

Current radial expanding tire bead sealing rings such as that disclosed in U.S. Pat. No. 4,634,357 have various shortcomings. For example, the tire bead sealing ring assembly does not have a way to control the working range of the circumference. When mounting and dismounting the tire bead sealing ring assembly during the retreading process operators frequently over actuate the metal ring causing the metal ring circumference to become too small which causes the metal ring to disengage from the annular elastomeric sealing ring. This requires the end users to reseat the annular elastomeric sealing ring on to the radially expanding metal ring, which is time consuming and affects productivity.

When an annular elastomeric sealing ring becomes worn it needs to be removed from the actuating metal ring assembly and a new one needs to be installed. An inner diameter of the annular elastomeric sealing ring has a dovetail channel formed therein that receives the radially expanding metal ring assembly to create an interference fit therebetween. An installer must stretch the annular elastomeric sealing ring inner diameter over the outer diameter of the actuating metal ring assembly which is difficult and time consuming.

Verifying the proper pressure is applied to form a reliable seal after actuating the tire bead sealing ring assembly to the locked position is difficult. The operator is supposed to use a U-shaped mechanical gauge to measure if the proper pressure is applied. This is difficult and time-consuming and for this reason most operators do not perform this measurement. During the retreading process verifying the proper pressure is applied to form a reliable seal is critical. Too much pressure causes premature failure of the annular elastomeric seal, not enough pressure will cause an unreliable seal which could lead to a bond failure between the tread and the tire casing.

The actuating mechanism subassembly is activated in the most efficient and ergonomical manner at a 6:00 position as this enables an operator to utilize their body weight and gravity to engage. However, as a saddle is integrated in the actuating mechanism subassembly and is used to secure the tire retread assembly to a J-hook, the tire retread assembly must be rotated to the 12:00 position. Rotating the tire retread assembly from 6:00 to 12:00 is an additional step and may result in damage to the valve and/or the hose connected to the valve becoming tangled. Accordingly, operators may opt to install the tire bead sealing ring in the 12:00 position to avoid the step of rotating the complete tire retread assembly to mount it on the J-hook. When installing the tire bead sealing ring in a 12:00 position the operator is at an ergonomic disadvantage for actuating which can cause fatigue and possible injury.

The locking mechanism assembly is subject to certain parts failing. Failures led to lost production and the need for maintenance. The failure of at least some parts may be complicated and time consuming and some of the failures may be too complicated for an operator to perform (may not be field serviceable). For example, one of the most frequent failures occurs where a spring shaft is spot welded to a clevis as the spot weld fatigues from frequent actuations of the spring-loaded locking mechanism. Typical operators are not equipped to spot weld the device back together.

The actuating mechanism subassembly is riveted to opposing sides (e.g., tail and tongue) of the metal band. When the band is actuated the rivets located on each side of the metal band become in direct contact with each other as the tail of the band overlaps the tongue of the band. This direct contact causes the energy to be focused to a small point on the domed head of the rivet. This concentration of energy causes excessive friction and wears the rivet heads when actuating the locking mechanism. This wear leads to poor operation of the locking mechanism and eventually the rivet head will fail. While it is possible to install new rivets in the field, the failure results in the equipment and operator not being available for a period of time.

The actuating mechanism subassembly includes rails that are held in parallel by push-nuts on a clevis pin and a sled guide pin. When latching the actuating mechanism subassembly to a locked position the rails tend to spread outward exerting pressure on the push-nuts. This pressure causes friction and eventually causes the push-nuts to fail and pop-off. While it is possible to install new push-nuts in the field, the failure results in the equipment and operator not being available for a period of time.

The spring-loaded locking mechanism assembly includes a handle that slips on and is not integrated into the construction of the assembly. Accordingly, the handle frequently slips off when the operator actuates the locking mechanism which is frustrating for an operator and could result in the assembly disengaging from the retread assembly or injuring the operator.

Right and left side plates of a nested locking mechanism subassembly can bend when latching into a locked position. This can cause the right and left side plates of the subassembly to either toe inward or outward. Toeing inward or outward will misalign the axis of pivot holes in the subassembly because the side plates are no longer parallel to each other. This misalignment can make inserting the quick release pivot pin difficult, affecting the ease of use and functionality.

Rails on the housing are used to hang the tire retread assembly on a J-hook. Accordingly, the rails are required to support an entire weight of the tire retread assembly when mounting and dismounting it on the J-hook. The housing rails eventually wear and deform from constant use during the retreading process. This wear causes friction between the nested locking mechanism subassembly and the housing rails when actuating the assembly, affecting the ease of use and functionality. Furthermore, some tire and tread combinations have very little clearance between the crown of the tire and the top of a J-hook making it difficult to mount. Mounting such a tire retread assembly on a saddle formed by the rails of the actuating mechanism subassembly is difficult.

What is needed is a radial expanding tire bead sealing ring assembly that addresses the various shortcomings of the current implementation.

### SUMMARY

A radial expanding tire bead sealing ring assembly is proposed that includes various novel improvements over known technologies in the tire bead sealing system commonly used today. According to one embodiment, a spring-loaded locking mechanism assembly includes multiple pivot points to provide a working range for a circumference of a radially expanding metal ring to accommodate variations across different tire brands for a proper fit and seal. Each of the pivot points incrementally increase the working range of the circumference of the radially expanding metal ring. The pivot points are spaced proportional to the working range of the spring. When in a locked position, the locking mechanism will apply a constant spring pressure to maintain a hermitic seal during the retreading process.

According to one embodiment, the spring-loaded locking mechanism assembly includes an indexing mechanical stop to control range the radially expanding metal ring can be contracted. The mechanical stop indexes when adjusting between the multiple pivot points. This controls the range the radially expanding metal ring can be contracted at each pivot point and prevents over actuating (too much contraction) and disengaging of the ring from a dove tail channel of an annular resilient elastomeric radial sealing ring. The mechanical stop ensures that the radially expanding metal ring remains properly engaged in the dove tail channel of the annular elastomeric sealing ring throughout the entire working range.

According to one embodiment, the spring-loaded locking mechanism assembly includes a specific pivot point which bypasses the mechanical stop to enable additional retraction of the metal ring that is required for replacing a worn elastomeric sealing ring with a new one. The specific pivot point enables the outer diameter of the radially expanding metal ring to be contracted to its smallest circumference, minimizing or eliminating the interference fit with the inner diameter of the annular elastomeric seal. This makes installing the new annular elastomeric sealing ring easier.

According to one embodiment, the spring-loaded locking mechanism assembly includes an integrated “GO” and “NO-GO” site gauge providing visual feedback that the proper pressure has been applied to the resilient elastomeric sealing ring to compress the curing envelope against the rim area of the tire to form a hermetic seal. This visual feedback improves productivity and makes the process easier. After visually verifying the proper pressure has been applied a vacuum test should always be performed before vulcanizing a tire. The vacuum test verifies the tire bead sealing assembly is properly seated and there are no leaks in the curing envelope or tire casing and a hermetic seal has been created.

According to one embodiment, the radially expanding metal ring includes a separate J-hook saddle on an opposite side as the spring-loaded locking mechanism assembly. Using this saddle to hang the retread tire assembly on a J-hook allows the operator to install the tire bead sealing ring assembly in a 6:00 position to gain leverage and use their body weight to actuate the unit without rotating the tire. This eliminates the need to rotate the tire to hang it and provides for safer and more ergonomic operation of the tire bead sealing assembly.

According to one embodiment, the spring-loaded locking mechanism assembly uses a screw instead of a spot weld to attach a spring shaft to a clevis. Eliminating the spot weld improves durability and makes the spring shaft and clevis field serviceable. This extends the useful life of the assembly.

According to one embodiment, the spring-loaded locking mechanism assembly includes an integrated sled bearing that includes counter sunk holes for receiving the rivet heads which prevent them from contacting the metal band. The bearing distributes the energy across a larger surface which reduces friction, providing smoother movement when actuating the locking mechanism. The sled bearing improves durability and extends the useful life of the radially expanding metal ring making it more cost effective.

According to one embodiment, the rails of the actuating mechanism subassembly are held parallel by a standoff. This standoff does not move with the sled and will hold the actuating mechanism subassembly rails parallel in a locked or unlocked position. The fixed position standoff eliminates the outward pressure on the push-nuts preventing them from popping off, providing smoother operation, reducing friction and maintenance.

According to one embodiment, the locking mechanism assembly has an integrated handle that cannot slip off. The integrated handle is hollow to decrease weight and is ergonomically formed to fit the operator's hand making it easier to use.

According to one embodiment, the locking mechanism assembly includes two parallel plates (left and right) that each include a flange extending upwards therefrom to increase strength and rigidity in order to prevent the side plate from toeing inward or outward. A standoff is secured between the two flanges with, for example, screws to maintain parallelism and alignment of the axis of the pivot holes. The screws securing the standoff also serve as the indexing mechanical stop to control the working range mentioned above.

According to one embodiment, the parallel plates of the locking mechanism assembly both have flanges formed at 90-degree so as to extend toward the other plate and create an integrated saddle to nest the J-hook during the retreading process. The integrated J-hook saddle has an elevation that prevents the J-hook from contacting the housing rails. This will eliminate the wear and deformation of the housing rails, improving durability and ease of use. The integrated J-hook saddle also improves clearances for larger diameter tires and deeper tread patterns. This makes mounting the complete tire retread assembly on the J-hook easier.

### BRIEF DESCRIPTION OF DRAWINGS

The features and advantages of the various embodiments will become apparent from the following detailed description in which:

FIGS. 1A-B illustrate a perspective and a cross-sectional view of an example retreaded tire within an annular elastomeric curing envelope, according to one embodiment;

FIG. 2A illustrates a cross-sectional view of an example radial expanding tire bead sealing ring assembly being inserted within the tire to secure the annular elastomeric curing envelope to the bead, according to one embodiment;

FIG. 2B is a close-up of an example engagement of the envelope with the sidewall and the bead, according to one embodiment;

FIG. 3A illustrates a cross-sectional view of the example radial expanding tire bead sealing ring assembly with the actuating mechanism subassembly engaged and the ring assembly in a closed configuration, according to one embodiment;

FIG. 3B is a close-up of an example engagement of the envelope with the sidewall and the bead, according to one embodiment;

FIG. 4A illustrates a perspective view of an example radial expanding tire bead sealing ring assembly without the annular resilient elastomeric radial sealing ring, according to one embodiment;

FIG. 4B illustrates an exploded view of an example radial expanding tire bead sealing ring assembly without the annular resilient elastomeric radial sealing ring, according to one embodiment;

FIG. 5 illustrates an exploded view of an example actuating mechanism subassembly, according to one embodiment;

FIG. 6 illustrates an exploded view of an example actuating device, according to one embodiment;

FIG. 7A illustrates a perspective view of an example radial expanding tire bead sealing ring assembly where an annular resilient elastomeric radial sealing ring is not secured to a radially expanding metal ring, according to one embodiment;

FIG. 7B illustrates a perspective view of an example radial expanding tire bead sealing ring assembly as the annular resilient elastomeric radial sealing ring is being secured on the radially expanding metal ring, according to one embodiment;

FIG. 8A illustrates a perspective view of an example radial expanding tire bead sealing ring assembly in a disengaged configuration so that it can be installed in a tire, according to one embodiment;

FIG. 8B illustrates a close-up cross-sectional perspective view of the example actuating mechanism subassembly of FIG. 8A, according to one embodiment;

FIG. 9A illustrates a perspective view of an example radial expanding tire bead sealing ring assembly in an engaged configuration so the envelope is pressed against the tire, according to one embodiment;

FIG. 9B illustrates a close-up cross-sectional perspective view of the example actuating mechanism subassembly of FIG. 9A, according to one embodiment;

FIG. 10A illustrates a perspective view of an example radial expanding tire bead sealing ring assembly in an engaged configuration, according to one embodiment;

FIG. 10B illustrates a close-up cross-sectional perspective view of the example actuating mechanism subassembly of FIG. 10A, according to one embodiment;

FIG. 11 illustrates a perspective view of a tire within a curing envelope utilizing a saddle (on opposites side as actuating mechanism subassembly) to mount to a J-hook for placement in a curing chamber, according to one embodiment; and

FIG. 12 illustrates a perspective view of a tire within a curing envelope utilizing a saddle formed in the actuating mechanism subassembly to mount to a J-hook for placement in a curing chamber, according to one embodiment.

### DETAILED DESCRIPTION

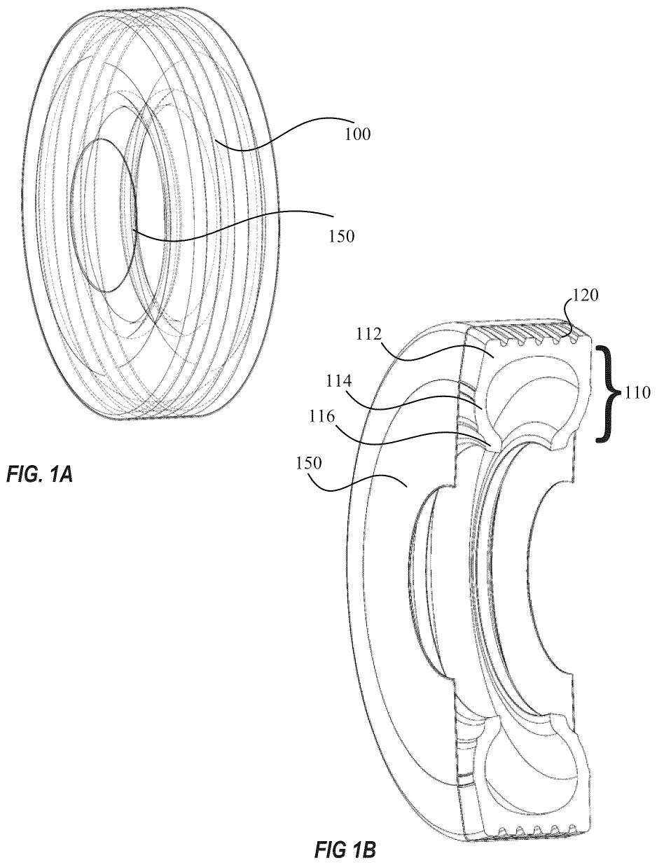

FIGS. 1A-B illustrate a perspective and a cross-sectional view of an example retreaded tire 100 within an annular elastomeric curing envelope 150. FIG. 1A simply illustrates a retread tire 100 (shown in dotted lines) wrapped by an annular elastomeric curing envelope 150. FIG. 1B illustrates additional details regarding the retreaded tire 100. The retreaded tire 100 includes an original tire casing 110 (tire casing which is being reused) and a new tire tread 120 secured thereto. The bonding agent used to secure the tread 120 to the casing 110 is not shown for ease of illustration. The tire casing 110 is made up of a crown 112, sidewalls 114 and beads 116. The crown 112 is an uppermost portion of the casing 110 that the tread 120 is secured to. The sidewalls 114 are the side of the casing 110 that extends downward from the crown 112. The beads 116 are the end of the casing 110 that connect to a rim. The annular elastomeric curing envelope 150 is wrapped around the tread 120 and the sidewalls 114 and extends past the beads 116.

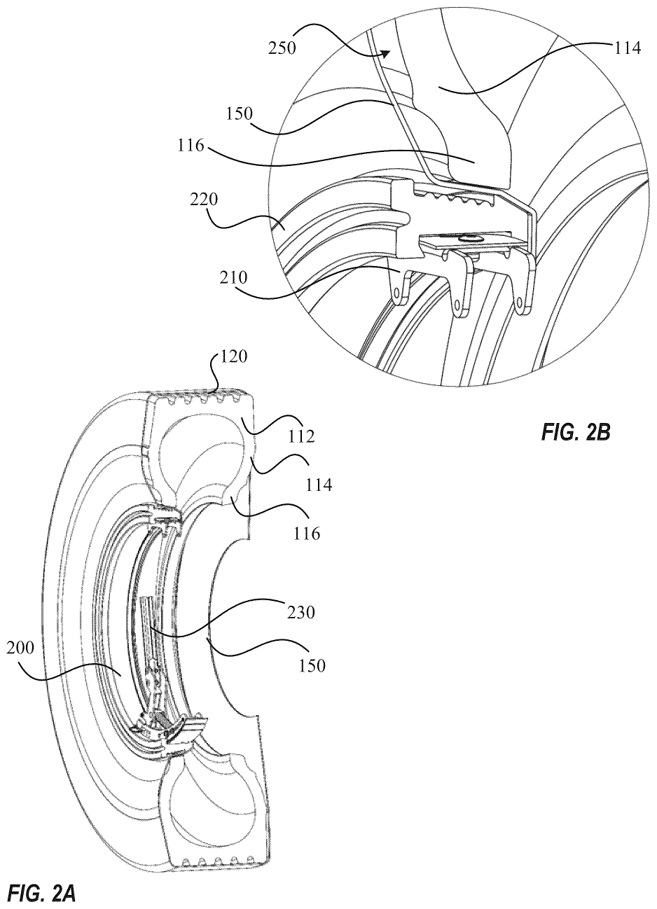

FIG. 2A illustrates a cross-sectional view of an example radial expanding tire bead sealing ring assembly 200 being inserted within the tire 100 to secure the annular elastomeric curing envelope 150 to the bead 116 of one side of the retreaded tire 100. A majority of the details of the ring assembly 200 are not identified or discussed in FIG. 2A as they will be described in more detail later. An actuating mechanism subassembly 230 of the ring assembly 200 is disengaged at this point so that the ring assembly 200 is in an open configuration. FIG. 2B is a close-up of the engagement of the envelope 150 with the sidewall 114 and the bead 116. As illustrated, at this point there is space 250 between the envelope 150 and the tire 100 (sidewall 114 and bead 116). The close-up view also shows a radially expanding metal ring 210 and an annular resilient elastomeric radial sealing ring 220 of the ring assembly 200.

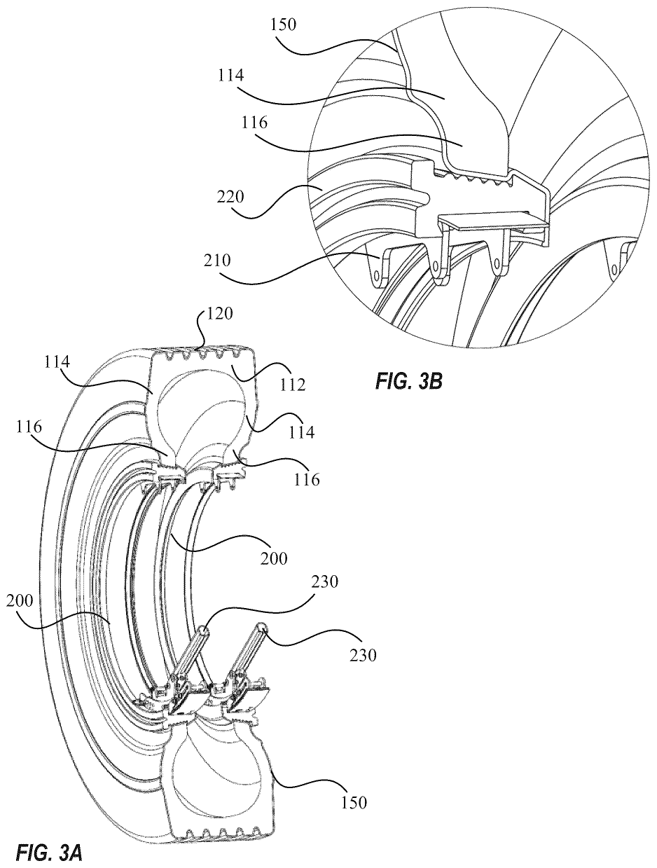

FIG. 3A illustrates a cross-sectional view of the example radial expanding tire bead sealing ring assembly 200 inserted within both sides of the tire 100 where the actuating mechanism subassembly 230 is engaged so that the ring assembly 200 is in a closed configuration. In addition, at this point a vacuum has been created. FIG. 3B is a close-up of an example engagement of the envelope 150 with the sidewall 114 and the bead 116. As illustrated, at this point the space 250 no longer exists and the envelope 150 and the tire 100 (sidewall 114 and bead 116) are in direct contact.

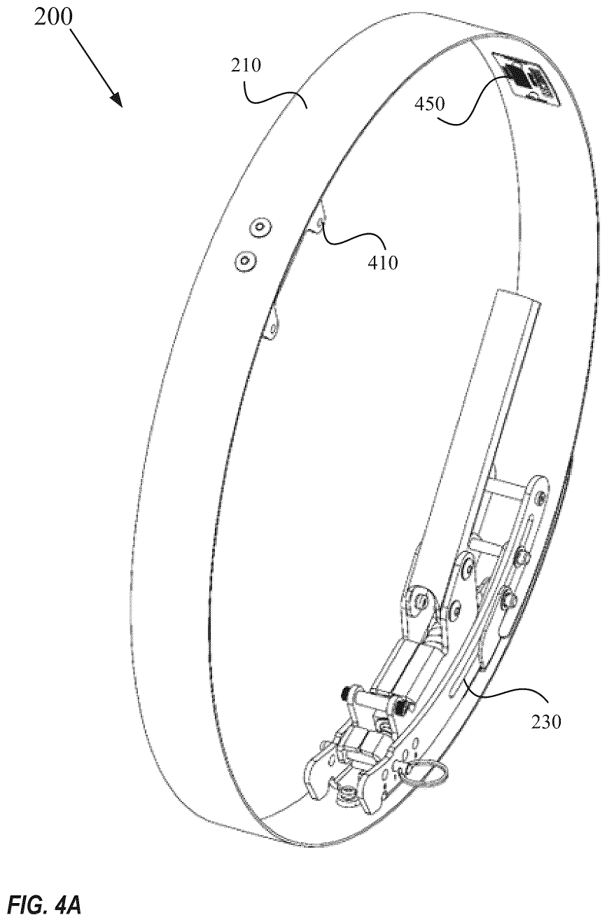

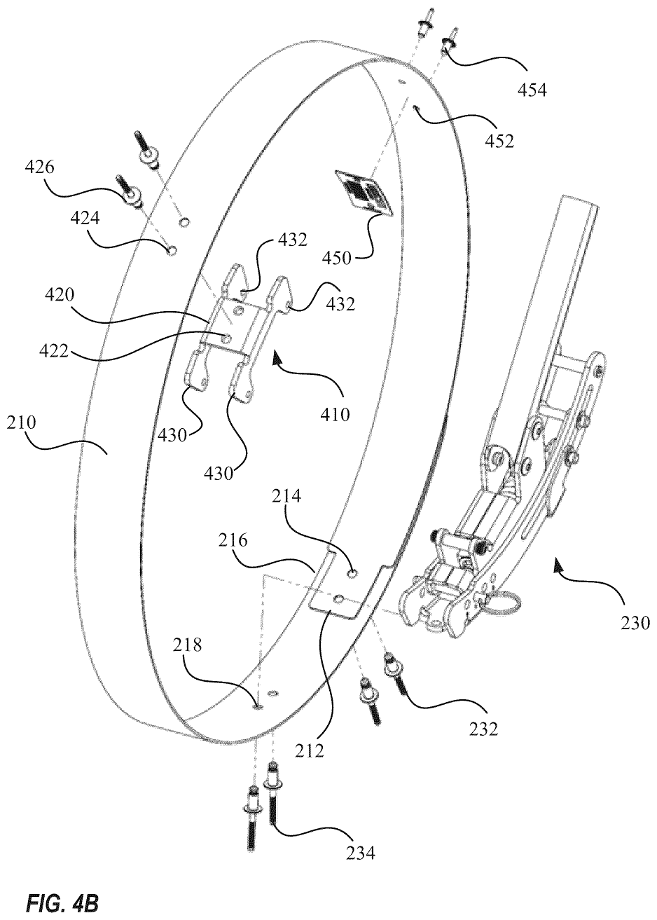

FIG. 4A illustrates a perspective view of an example radial expanding tire bead sealing ring assembly 200 without an annular resilient elastomeric radial sealing ring 220. The actuating mechanism subassembly 230 is mounted to one side of the radially expanding metal ring 210. In addition, on an opposite side of the metal ring 210 a saddle 410 is mounted thereto. The saddle 410 is utilized to secure a hook (e.g., J-hook) to hold the tire 200 when it is placed in the curing chamber. The metal ring 210 may also have an identification tag 450 secured thereto.

FIG. 4B illustrates an exploded view of an example radial expanding tire bead sealing ring assembly 200 without an annular resilient elastomeric radial sealing ring 220. The overlapping of the two ends (e.g., tongue 212 and tail 216) of the metal ring 210 are visible. The tongue 212 is narrower than the remainder of the ring 210 and extends over the tail 216 and varying distances of the ring 210 to control the circumference of the ring 210. The tongue 212 includes holes 214 (two illustrated) formed therein for receiving rivets 232 for securing a portion of the actuating mechanism subassembly 230 thereto. The metal ring 210 (toward the tail 216 and in close proximity to the tongue 212 when overlapped) includes holes 218 (two illustrated) formed therein for receiving rivets 234 for securing a portion of the actuating mechanism subassembly 230 thereto. As will be described in more detail later, the actuating mechanism subassembly 230 controls the distance between the holes 214 and the holes 218 and therefore the amount of overlap between the tongue 212 and the tail 216 of the metal ring 210. The amount of overlap controls the circumference of the metal ring 210. The circumference selected is to accommodate variations in tire brands, manufacturing and wear.

The metal ring 210 also includes one or more holes 424 (two illustrated) formed therein for receiving rivets 426 for securing the saddle 410 thereto and holes 452 (two illustrated) formed therein for receiving rivets 454 for securing the identification tag 450 thereto. The saddle 410 may include a main surface 420 having one or more holes 422 (two illustrated) formed therein in alignment with the holes 424 in order to secure the saddle 410 to the ring 210 with the rivets 426. The saddle 410 may also include arms 430 extending from each corner of the main surface 420. The ends of each arm 430 may include a flange 432 extending in a direction opposite the main surface 420. The flanges 432 are used to secure a J-hook within the saddle 410.

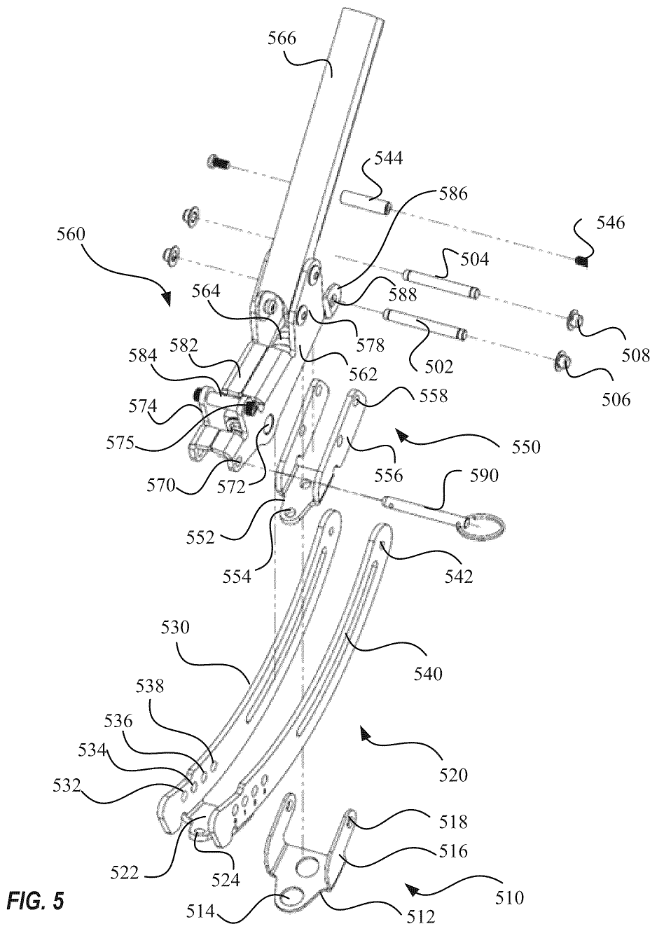

FIG. 5 illustrates an exploded view of an example actuating mechanism subassembly 230. The assembly 230 includes an integrated sled bearing 510, a slide bracket 520, a sled 550, and an actuating device 560. The sled bearing 510 includes a floor 512 and two parallel walls 516 extending perpendicular from the floor 512. The floor 512 includes one or more counter sunk holes 514 (two illustrated) formed therein. The two parallel walls 516 include one or more aligned holes 518 (one illustrated) formed therein. The slide bracket 520 includes a floor 522 and two parallel walls 530. The floor 522 includes one or more holes 524 (two in example embodiment, but only one visible) formed therein. The walls 530 include a plurality of aligned pivot holes 532, 534, 536, 538 (four illustrated) located toward a first side thereof, aligned guide slots 540 and aligned holes 542 located on a second side thereof. A standoff 544 is secured between each of the walls 530 on the second end of the slide bracket 520 to assist in keeping the walls 530 aligned. The standoff 544 is secured to the walls 530 with screws 546 passing through the holes 542. The sled 550 includes a floor 552 and two parallel walls 556 extending perpendicular from the floor 552. The floor 552 includes one or more holes 554 (two illustrated) formed therein. The two parallel walls 556 include one or more aligned holes 558 (two illustrated) formed therein.

The actuating device 560 includes two parallel side walls 562 forming a main body, a spring device (only a spring 564 and clevis 586 are visible) and a handle 566. The parallel side walls 562 include an aligned pivot hole 570 located on a first end thereof, an aligned stud hole 572, a first flange 574 extending upward, aligned holes 576 (one in example embodiment, but not visible) in the first flange 574, a second flange 578 extending upward from a second end thereof, one or more aligned holes 580 (two in example embodiment, but not visible) in the second flange 578 and upper walls 582 that extend perpendicular to the sidewalls 562 in a direction toward the other sidewall 562. According to one embodiment, the upper walls 582 are formed by bending an appropriate portion of the sidewall 562. The upper walls 582 between the first flange 574 and the second flange 578 create a saddle that may be used to receive a hook (e.g., J-hook) to hold the tire. The handle 566 is secured to the second flange 578 and extends away from the main body (parallel side walls 562). A standoff 584 is secured between the first flanges 574, for example, with screws 575 passing through the holes 576. The screws 575 securing the standoff 584 serve as the indexing mechanical stop as will be described in more detail below.

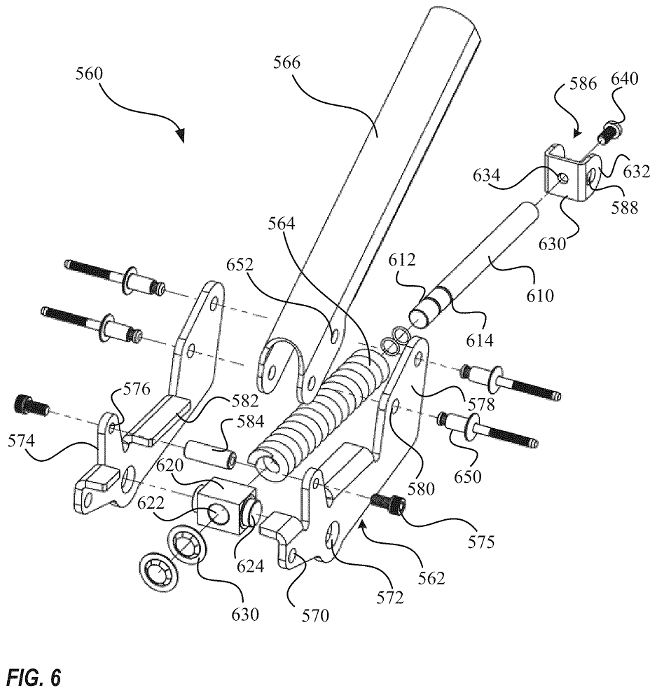

As illustrated in FIG. 5, the spring device is located within the main body (parallel side walls 562) so only the spring 564 and the clevis 586 with aligned holes 588 is visible. One side of the spring device is secured to the main body 562 via the aligned stud holes 572 and the other side is secured to the sled bearing 510, the slide bracket 520 and the sled 550 via the clevis 586. The actuating device 560 including details about the spring device and how it is secured to the side walls 562, the sled bearing 510, the slide bracket 520 and the sled 550 will be discussed in more detail with respect to FIG. 6.

The sled bearing 510 and the sled 550 are secured on opposite sides of the tongue 212 of the metal ring 210 with the rivets 232 passing through the holes 514, 214 and 554. The counter-sunk holes 514 of the sled bearing 510 are to receive heads of the rivets 232 which prevent them from contacting the metal ring 210. The sled bearing 510 distributes the energy across a larger surface of the metal ring 210 which reduces friction, providing smoother movement when actuating the actuating mechanism subassembly 230. The slide bracket 520 is secured to the metal ring 210 with the rivets 234 passing through the holes 218 and 524.

The walls 516 of the sled bearing 510 are located outside the walls 530 of the slide bracket 520, the walls 556 of the sled 550 are located inside the walls 530 of the slide bracket 520 and the walls of the clevis 586 are located within the sled 550. The sled bearing 510, the sled 550 and one end of the spring device via the clevis 586 are secured together and are moveably connected to the slide bracket 520. The sled bearing 510 is connected to the slide bracket 520, the sled 550 and the clevis 586 with a first guide pin 502 passing through the holes 518, the slots 540, the holes 558 and the holes 588. The sled 550 is further connected to the slide bracket 520 with a second guide pin 504 passing through the slots 540 and the holes 558. The guide pins 502, 504 are held in place with caps 506, 508 secured on each end thereof. The sled bearing 510, the sled 550 and the clevis 586 may move with respect to the slide bracket 520 by sliding within the slots 540.

The sidewalls 562 of the actuating device 560 are pivotally connected to the slide bracket 520 with a pivot pin 590. The sidewalls 562 sit within the slide bracket 520 and the pivot holes 572 are aligned with an appropriate set of the pivot holes 532, 534, 536, 538 and then the pivot pin 590 is slid therethrough. The different pivot holes 532, 534, 536, 538 provide different pivot points for the actuating device 560. Each pivot point provides a different range for the circumference of the ring 210. The closer the pivot hole 532, 534, 536, 538 is to the first end of the slide bracket 520 the smaller the circumference range for the metal ring 210 is. An appropriate pivot point is selected to accommodate variations in tire brands, manufacturing and wear. The screws 575 securing the standoff 584 serve as the indexing mechanical stop to control range the radially expanding metal ring 210 can be contracted for multiple pivot points to prevent over actuating (too much contraction) and disengaging of the ring 210 from a dove tail channel of an annular resilient elastomeric radial sealing ring 220. The indexing mechanical stop ensures that the radially expanding metal ring 210 remains properly engaged in the dove tail channel of the annular elastomeric sealing ring 220 throughout the entire working range.

In the disengaged configuration, the actuating device 560 is pivoted away from the slide bracket 520 to minimize the circumference of the metal ring 210 to either insert the radial expanding tire bead sealing ring assembly 200 within the tire 100 or remove it from the tire 100. When the actuating device 560 is pivoted away from the slide bracket 520 the screws 575 abut the top of the first end of the sidewall 530 to prevent the actuating device from going any further. The pivot hole 532 is used for replacing the annular resilient elastomeric radial sealing ring 220. In this configuration, the standoff 584 extends over the top of the first end of the sidewall 530 so the screws 575 do not act as a mechanical stop and enable additional contraction to allow the annular resilient elastomeric radial sealing ring 220 to be more easily placed over the metal ring 210. The operation of mechanical stop will be discussed in more detail later.

FIG. 6 illustrates an exploded view of an example actuating device 560. The exploded view illustrates the spring assembly including the spring 564, a shaft 610, a pivot block 620 and the clevis 586. The spring 564 is located on the shaft 610. The pivot block 620 includes a hole 622 therethrough for receiving a first end of the shaft 610. The first end of the shaft 610 passes through the hole 622 and is secured in place with one or more connectors 630. The pivot block 620 further includes pivot studs 624 extending from each side that are received in the stud holes 572 of the side walls 568. A second end of the shaft 610 is secured to the clevis 588. The clevis 588 includes a face 630 and a pair of sidewalls 632. The face 630 includes a hole 534 formed therein for enabling a screw 640 to secure the clevis 586 to the shaft 610. The second end of the shaft 610 includes a hole (not visible) to receive the screw 640. The handle 566 includes holes 652 in alignment with the holes 580 to enable it to be secured to the side walls 568 with rivets 650.

Proper pressure needs to be applied to the resilient elastomeric sealing ring 220 to compress the curing envelope 150 against the bead 116 of the tire to form a hermetic seal. Too much pressure causes premature failure of the annular elastomeric seal, not enough pressure will cause an unreliable seal which could lead to a bond failure between the tread and the tire casing. Accordingly, the shaft 610 includes a site gauge to provide visual feedback via markings 612, 614 that the proper pressure has been applied. A first mark 612 identifies when sufficient pressure is applied (a go indication) and a second marking 614 identifies when too much pressure has been applied (a no-go indication). The visual feedback improves productivity and makes the process easier. The go and no-go indications will be described in more detail later.

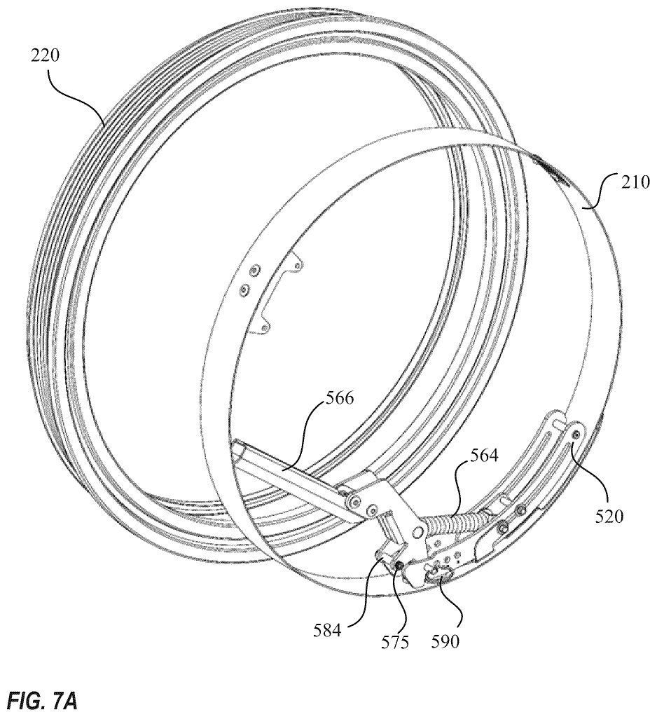

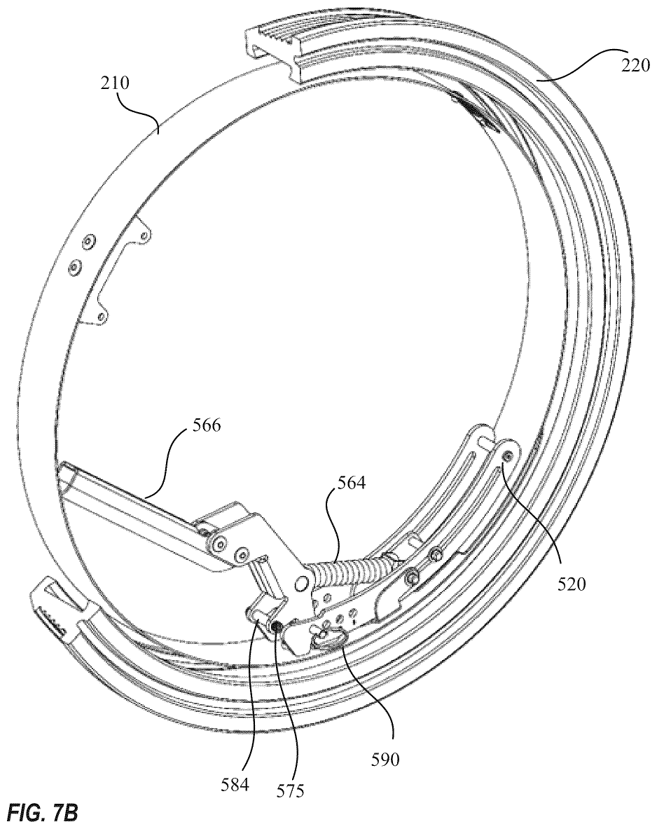

FIG. 7A illustrates a perspective view of an example radial expanding tire bead sealing ring assembly 200 where an annular resilient elastomeric radial sealing ring 220 is not secured to a radially expanding metal ring 210. In order to make it easier for the sealing ring 220 to be installed on the metal ring 210 the actuating device 560 is pivotally connected a first pivot point 532 in the slide bracket 520 so that the screws 575 securing the standoff 584 do not engage a front of the slide bracket 520 (bypassing the mechanical stop). This allows the metal ring 210 to be contracted more and thus make it easier to install the sealing ring 220 on the metal ring 210. FIG. 7B illustrates a perspective view of an example radial expanding tire bead sealing ring assembly 200 as the annular resilient elastomeric radial sealing ring 220 is being secured on the radially expanding metal ring 210.

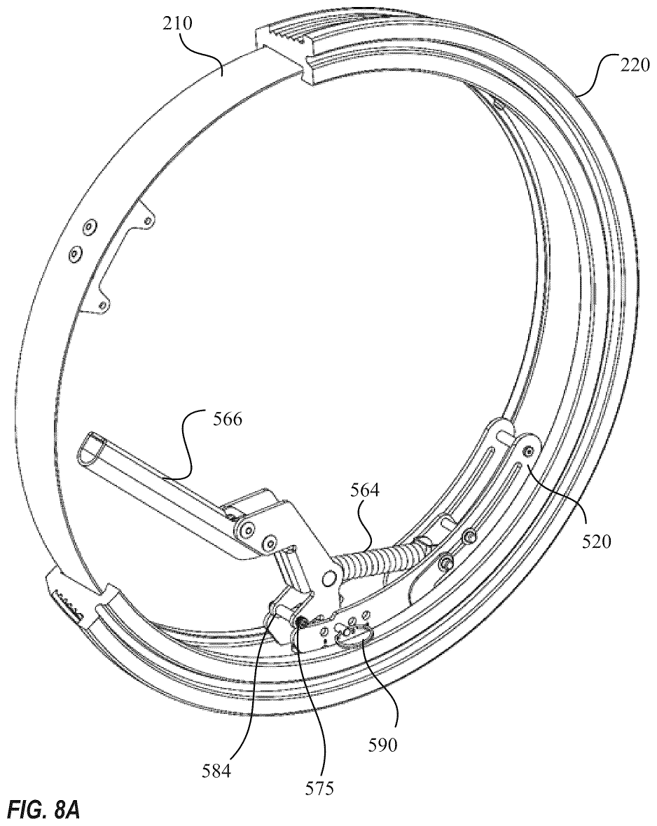

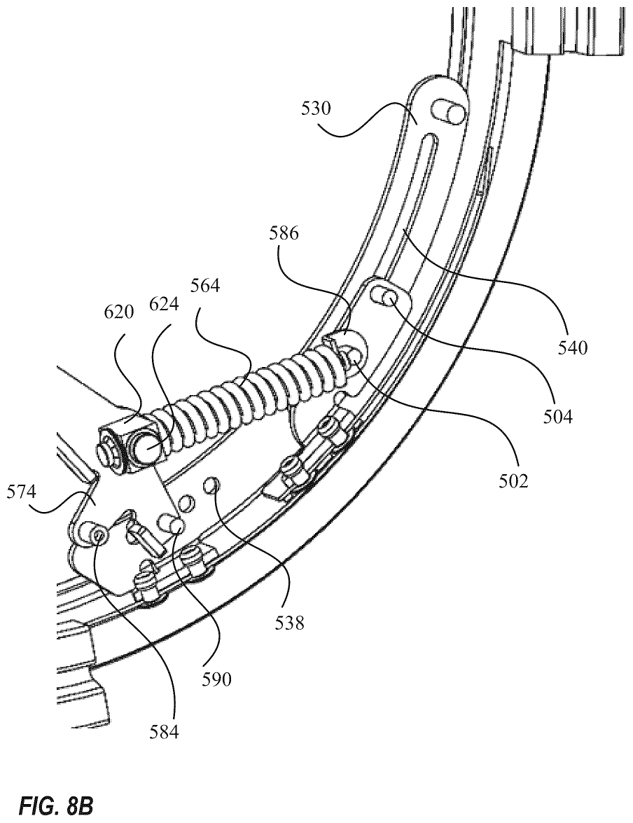

FIG. 8A illustrates a perspective view of an example radial expanding tire bead sealing ring assembly 200 in a disengaged configuration so that it can be installed in a tire 100. The actuating device 560 is pivotally connected to a second pivot point 534 in the slide bracket 520 so that the screws 575 securing the standoff 584 engage a front of the slide bracket 520 and act as a mechanical stop to limit the amount of contraction of the metal ring 210 to ensure the sealing ring 220 does not come off the metal ring 210. FIG. 8B illustrates a close-up cross-sectional perspective view of the example actuating mechanism subassembly 230 in the disengaged configuration of FIG. 8A.

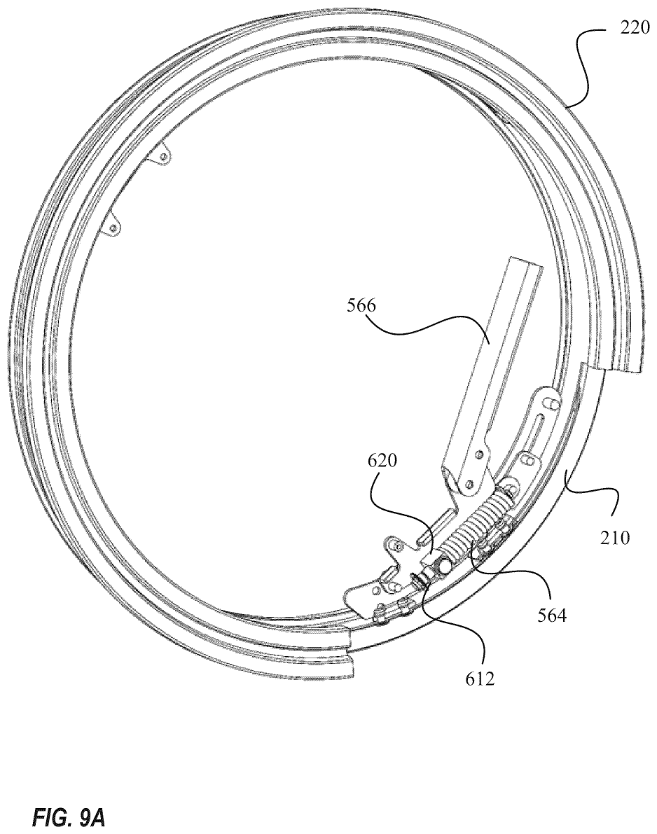

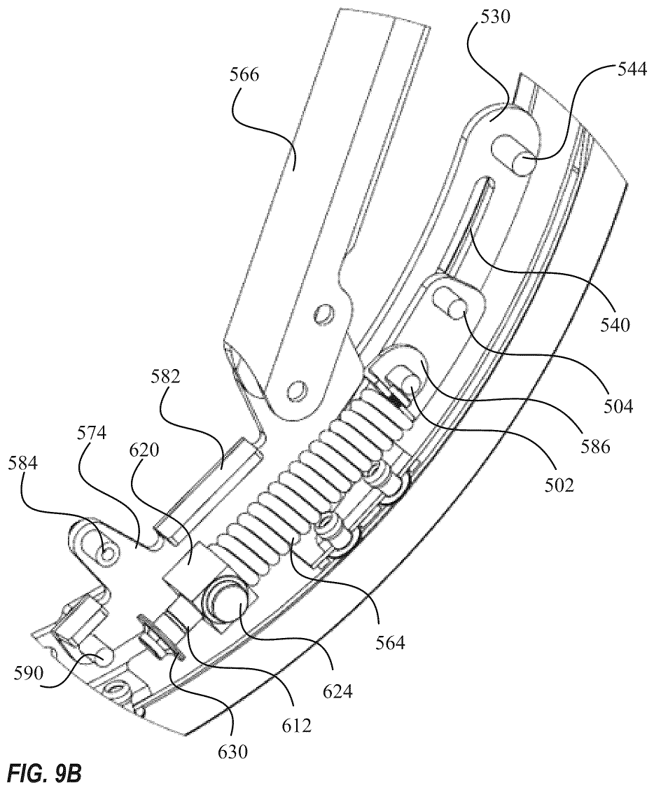

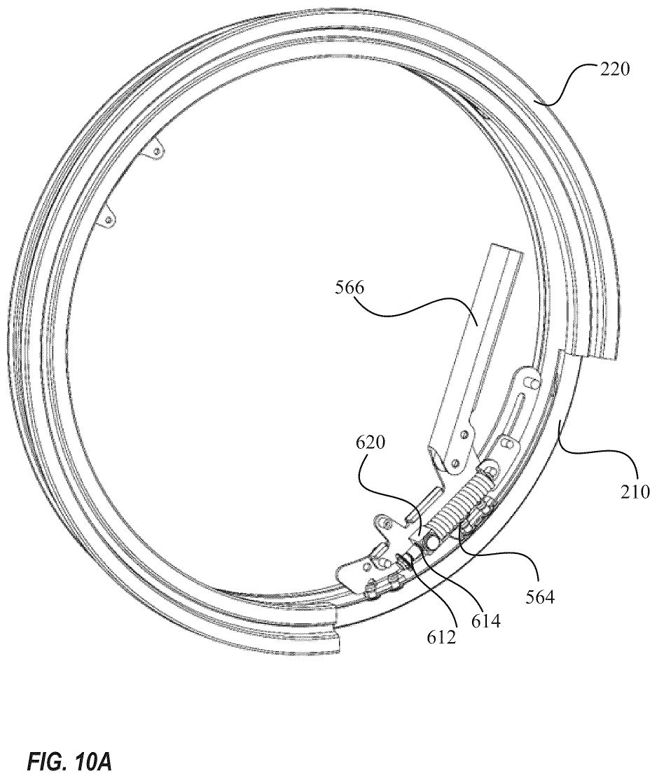

FIG. 9A illustrates a perspective view of an example radial expanding tire bead sealing ring assembly 200 in an engaged configuration so the envelope 150 is pressed against to the tire 100. The actuating device 560 is pivotally connected to a pivot point (e.g., second, third) in the slide bracket 520 and at this pivot point the pressure is sufficient as the pivot block 620 is passed the first (go) indicator 612. If the pivot block 620 did not pass the first (go) indicator 612 then sufficient pressure would not be applied and the pivot point would need to be moved back to another (e.g., third, fourth) pivot point in order to provide sufficient pressure. FIG. 9B illustrates a close-up cross-sectional perspective view of the example actuating mechanism subassembly 230 in the engaged configuration of FIG. 9A.

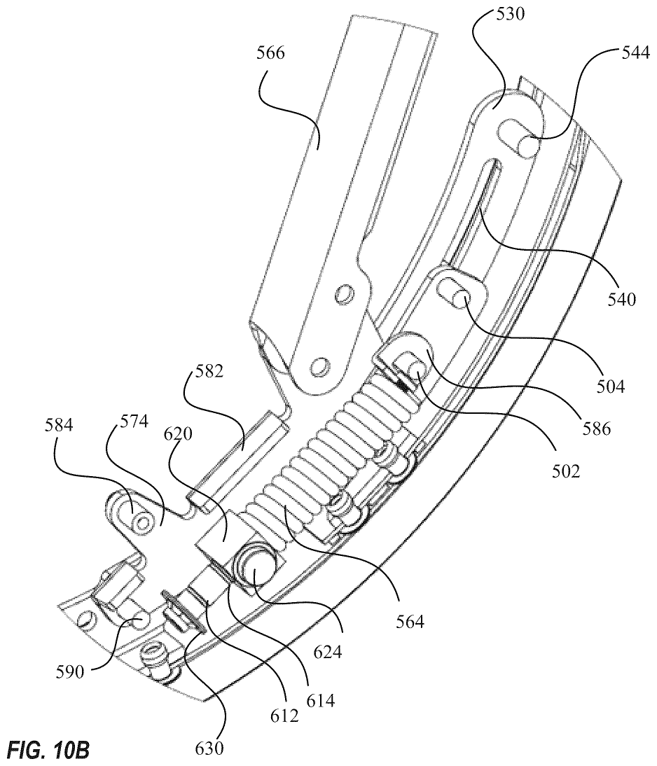

FIG. 10A illustrates a perspective view of an example radial expanding tire bead sealing ring assembly 200 in an engaged configuration. The actuating device 560 is pivotally connected to a pivot point (e.g., third, fourth) in the slide bracket 520 and at this pivot point too much pressure is being applied as the pivot block 620 is passed the second (no-go) indicator 614. In order to reduce the pressure to an acceptable level, the pivot point would need to be moved forward to another (e.g., second, third) pivot point. FIG. 10B illustrates a close-up cross-sectional perspective view of the example actuating mechanism subassembly 230 in the engaged configuration of FIG. 10A.

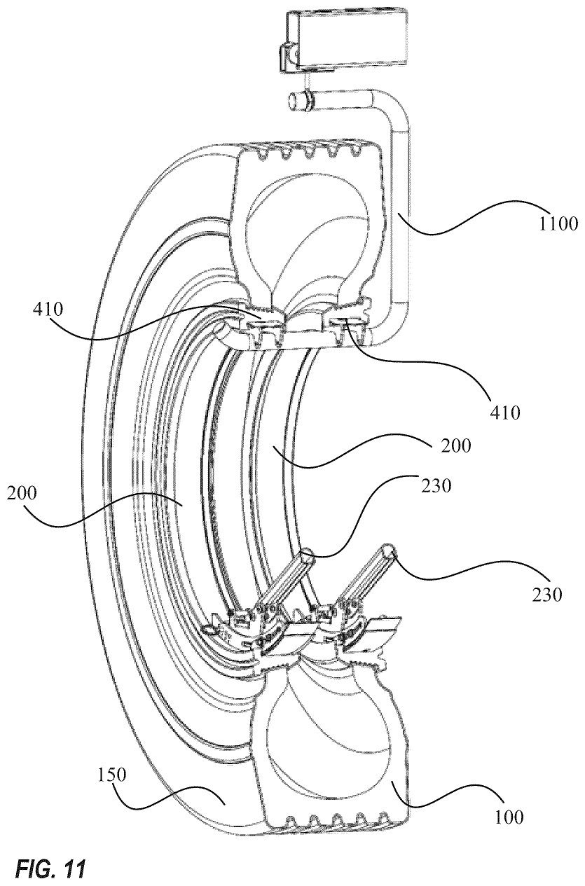

FIG. 11 illustrates a perspective view of a tire 100 within a curing envelope 150 utilizing a saddle 410 (on opposites side as actuating mechanism subassembly 230) to mount to a J-hook 1100 for placement in a curing chamber. This configuration enables the actuating mechanism subassembly 230 to be engaged at 6:00 and not require rotation of the tire 100.

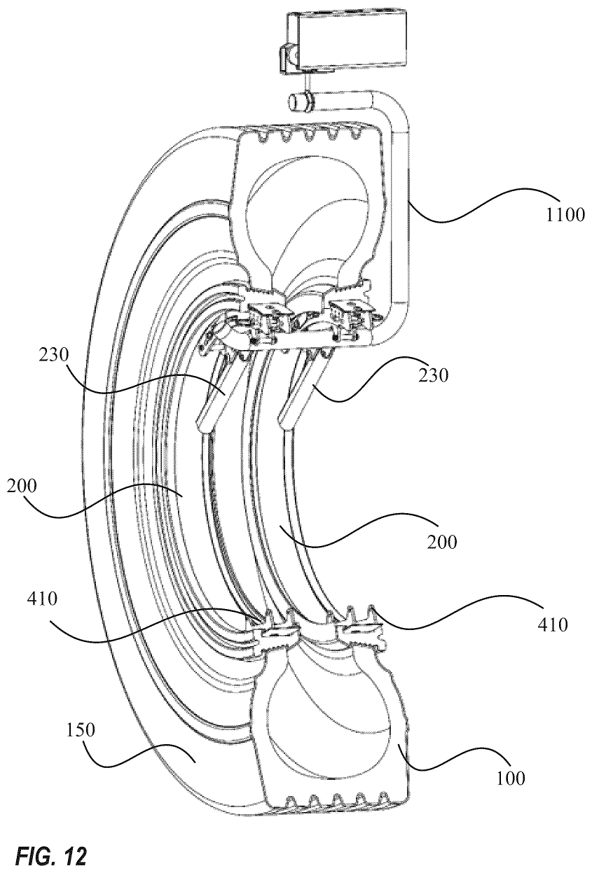

FIG. 12 illustrates a perspective view of a tire 100 within a curing envelope 150 utilizing a saddle formed in the actuating mechanism subassembly 230 to mount to the J-hook 1100 for placement in a curing chamber. This configuration requires the actuating mechanism to be rotated to 12:00 after subassembly 230 is engaged at 6:00 or the subassembly 230 to be engaged at 12:00.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A radial expanding tire bead sealing ring assembly to create a hermetic seal during a retreading curing process for radial tires, the assembly comprising
a radially expanding metal ring;
an elastomeric radial sealing ring secured to an exterior of the radially expanding metal ring; and
an actuating mechanism subassembly to adjust a circumference of the radially expanding metal ring, wherein the actuating mechanism subassembly includes a plurality of pivot points and each of the pivot points provides a different working range for the circumference, wherein the actuating mechanism subassembly includes a spring-loaded locking mechanism to lock the assembly in place in order to apply a constant spring pressure and create the hermetic seal.

2. The assembly of claim 1, wherein the actuating mechanism subassembly includes an indexing mechanical stop to control the circumference working range by limiting amount of contraction of the radially expanding metal ring for at least a subset of the plurality of pivot points.

3. The assembly of claim 2, wherein at least one of the plurality of pivot points bypasses the indexing mechanical stop to enable additional contraction of the radially expanding metal ring.

4. The assembly of claim 3, wherein the at least one of the plurality of pivot points that bypasses the indexing mechanical stop is utilized when replacement of the elastomeric radial sealing ring is required.

5. The assembly of claim 1, wherein the spring-loaded locking mechanism includes an integrated pressure indicator to provide visual feedback regarding whether proper pressure is being applied.

6. The assembly of claim 5, wherein the integrated pressure indicator includes a marking to indicate that sufficient pressure is provided to create the hermetic seal.

7. The assembly of claim 6, wherein if the integrated pressure indicator does not indicate that sufficient pressure is provided a current pivot point for the actuating mechanism subassembly should be moved to a different pivot point that provides a larger working range for the circumference.

8. The assembly of claim 5, wherein the integrated pressure indicator includes a marking to indicate too much pressure is provided.

9. The assembly of claim 8, wherein if the integrated pressure indicator indicates that too much pressure is provided a current pivot point for the actuating mechanism subassembly should be moved to a different pivot point that provides a smaller working range for the circumference.

10. The assembly of claim 1, wherein the actuating mechanism subassembly includes an integrated ergonomical hollow handle.

11. The assembly of claim 1, wherein the actuating mechanism subassembly includes a slide bracket mounted near a first side of the radially expanding metal ring and a sled mounted to a second end of the radially expanding metal ring, wherein the sled slides within the slide bracket to control the circumference of the radially expanding metal ring.

12. The assembly of claim 11, wherein the slide bracket includes two parallel plates having aligned glide slots that the sled traverses.

13. The assembly of claim 12, wherein the slide bracket includes a standoff at a far end to support the two parallel plates.

14. The assembly of claim 11, wherein the actuating mechanism subassembly further includes a sled bearing mounted to opposite side of the radially expanding metal ring as the sled to receive heads of rivets used to secure the sled to the radially expanding metal ring.

15. The assembly of claim 1, wherein the radially expanding metal ring includes a J-hook saddle on an opposite side as the actuating mechanism subassembly.

16. A radial expanding tire bead sealing ring assembly to create a hermetic seal during a retreading curing process for radial tires, the assembly comprising
a radially expanding metal ring;
an elastomeric radial sealing ring secured to an exterior of the radially expanding metal ring; and
an actuating mechanism subassembly secured to the radially expanding metal ring to adjust a circumference of the radially expanding metal ring, wherein the actuating mechanism subassembly includes
a slide bracket mounted near a first side of the radially expanding metal ring, wherein the slide bracket includes two parallel plates each plate having a plurality of aligned pivot points and aligned glide slots, wherein each of the plurality of pivot points provides a different working range for the circumference;
a sled mounted to a second end of the radially expanding metal ring, wherein the sled is movably connected to the glide slots of the slide bracket with a guide pin;
an actuating device pivotally connected to one of the plurality of aligned pivot points and the sled, wherein the actuating device includes an integrated handle and a spring-loaded locking mechanism to lock the assembly in place in order to apply a constant spring pressure and create the hermetic seal.

17. The assembly of claim 16, wherein the actuating device includes an indexing mechanical stop to limit movement of the actuating device within the slide bracket and accordingly contraction of the radially expanding metal ring and the circumference working range for at least a subset of the plurality of pivot points, wherein at least one of the plurality of pivot points bypasses the indexing mechanical stop to enable additional contraction of the radially expanding metal ring.

18. The assembly of claim 16, wherein the spring-loaded locking mechanism includes an integrated pressure indicator having a first marking to indicate that sufficient pressure is provided to create the hermetic seal and a second marking to indicate too much pressure is provided.

19. The assembly of claim 16, wherein the actuating mechanism subassembly further includes a sled bearing mounted to opposite side of the radially expanding metal ring as the sled to receive heads of rivets used to secure the sled to the radially expanding metal ring.

20. The assembly of claim 17, wherein
the actuating device includes two aligned flanges at a first end thereof,
a standoff is located between the aligned flanges to maintain proper alignment of the actuating device, and
the standoff is secured to the aligned flanges with screws, wherein the screws act as the indexing mechanical stop.
